(19) United States
(12) Patent Application Publication
(10) Pub. No.: US 2018/0007075 A1
(43) Pub. Date: Jan. 4, 2018

(54) MONITORING DYNAMIC DEVICE CONFIGURATION PROTOCOL OFFERS TO DETERMINE ANOMALY

(71) Applicant: HEWLETT PACKARD ENTERPRISE DEVELOPMENT LP, Houston, TX (US)

(72) Inventors: Shaun Wackerly, Roseville, CA (US); Duane Mentze, Roseville, CA (US); Shaun Wakumoto, Roseville, CA (US)

(21) Appl. No.: 15/548,498

(22) PCT Filed: Feb. 12, 2015
(86) PCT No.: PCT/US2015/015588

§ 371 Date: Aug. 3, 2017

(51) Int. Cl. H04L 29/06

(52) U.S. Cl. CPC H04L 63/1425

(57) ABSTRACT

Example embodiments disclosed herein relate to monitoring Dynamic Device Configuration Protocol offers via a control plane. In one example, an address range or multiple address ranges for sources of the Dynamic Device Configuration Protocol offers can be tracked. In this example, an anomaly can be determined based on one of the Dynamic Device Configuration Protocol offers and the address range(s).

### BACKGROUND

A network can include a variety of devices that transfer data throughout the network. This data is typically contained within packets that are transferred by switches, routers, or other network devices. Often times, software-defined networking (SDN) devices are used for implementing a data network.

### BRIEF DESCRIPTION OF THE DRAWINGS

The following detailed description references the drawings, wherein:

FIG. 1 is a block diagram of a Software Defined Networking controller capable of determining an anomaly from monitoring of Dynamic Device Configuration Protocol offers, according to one example;

FIG. 2 is a block diagram of a system including a Software Defined Networking controller capable of determining an anomaly from monitoring of Dynamic Device Configuration offers, according to one example;

FIG. 3 is a flowchart of a method for determining an anomaly based on identified address ranges of Dynamic Device Configuration Protocol servers, according to one example;

FIG. 4 is a block diagram of a computing device capable of determining an anomaly based on identified address ranges of Dynamic Device Configuration Protocol servers, according to one example;

FIG. 5 is a flowchart of a method for probing Dynamic Device Configuration Protocol servers for served address ranges, according to one example; and

FIG. 6 is a flowchart of a method for performing a security action based on a determined anomaly, according to one example.

### DETAILED DESCRIPTION

Malicious or suspicious behavior by network end-hosts can impact network availability and security for other network end-hosts. Malicious activity or behavior is when an end-host is explicitly attempting to disrupt network behavior for other end-hosts on the network. Suspicious activity is behavior that could possibly be malicious or could be normal network activity.

One specific malicious or suspicious activity includes an end-host to respond to requests as if it were an approved Dynamic Device Configuration Protocol (DDCP) server. DDCP is any network protocol using dynamically addressed networks (e.g., Internet Protocol (IP) networks such as IPv4, IPv6) for dynamically distributing network configuration parameters from a DDCP server to DDCP end-hosts. These network configuration parameters can include parameters such as IP addresses, the IP address of the DDCP server, the IP address of a gateway, Domain Name System (DNS) servers, Windows Internet Name Service (WINS) servers, etc. An example of a DDCP protocol is the Dynamic Host Configuration Protocol (DHCP), which is a standardized protocol.

A “rogue” DDCP server on the network can be malicious, suspicious, or otherwise unwanted. A rogue DDCP server is an end-host that exhibits DDCP server functionality (e.g., by responding to requests and handing out addresses) but is not the official DDCP server for a given address range. Some kinds of computer viruses and other malicious software set up rogue DDCP. For example, if a rogue DDCP is set to provide as default gateway an IP address controlled by malware, malware can sniff traffic sent by clients to other networks, which may violate network security policies and/or user privacy. In this example, establishing the rogue DDCP server as a gateway would mean that all traffic from these clients would be sent through the malicious host (which may look at the traffic). Further, in some examples, if the network configuration provided by the rogue DDCP server differs from the official ones, a client accepting an IP address from it may experience network problems (e.g., not being able to communicate with other machines on the network).

A switch may be configured to sniff DDCP assignments and enforce those address assignments on its own ports and virtual local area networks (VLANs). However, this would not scale if malicious or suspicious behavior occurs at another switch in the same dynamically-assigned subnet.

Accordingly, various embodiments described herein relate to using a Software Defined Networking (SDN) controller to manage switches to determine whether a rogue DDCP server is present in a network. Further, the SDN controlled system can mitigate risks from the rogue DDCP server (e.g., by disconnecting the rogue DDCP server, blocking the rogue DDCP server from the network, etc.).

Processes described herein can be used for detecting and mitigating DDCP traffic from end-hosts that is not part of an approved network service. In certain examples, these methods can include historical validation against known ranges and locations, address pool determination, and consumption. To detect a rogue DDCP server, an SDN controller can observe each DDCP Offer being transmitted through the controlled network. The respective switches in the network can be configured to send such messages of DDCP activity to the SDN controller. The SDN controller keeps track of the source (e.g., IP address, Media Access Control (MAC) address, port, etc.) of the DDCP Offers. This can be used to build a data structure (e.g., a table, a linked list, etc.) that associates the DDCP management function with particular sources on the controlled network. Other information can also be tracked (e.g., which IP addresses are assigned to which devices by which source DDCP servers).

In one example, if offers are made by another server while the original server is still online, then the second server would be suspicious. This can be determined by comparing an offer made by the second server to an address range already determined to be served by another DDCP server. In some circumstances, the second server may be a backup or otherwise legitimate. In other circumstances, the second server may be unauthorized or otherwise malicious. The SDN controller can then quarantine, more deeply inspect, or otherwise punish the source of suspicious activity. The analysis can also be based on time. For example, if the original server and the second server come online within a short period of time, both may be considered suspicious. On the other hand, if the original server came online and was there for a threshold amount of time, it can be considered a baseline server, where it is assumed to be legitimate. The threshold time can be customized.

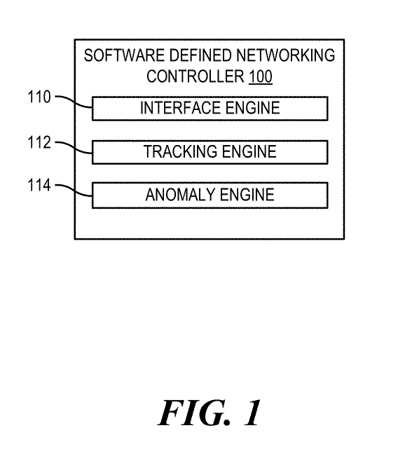

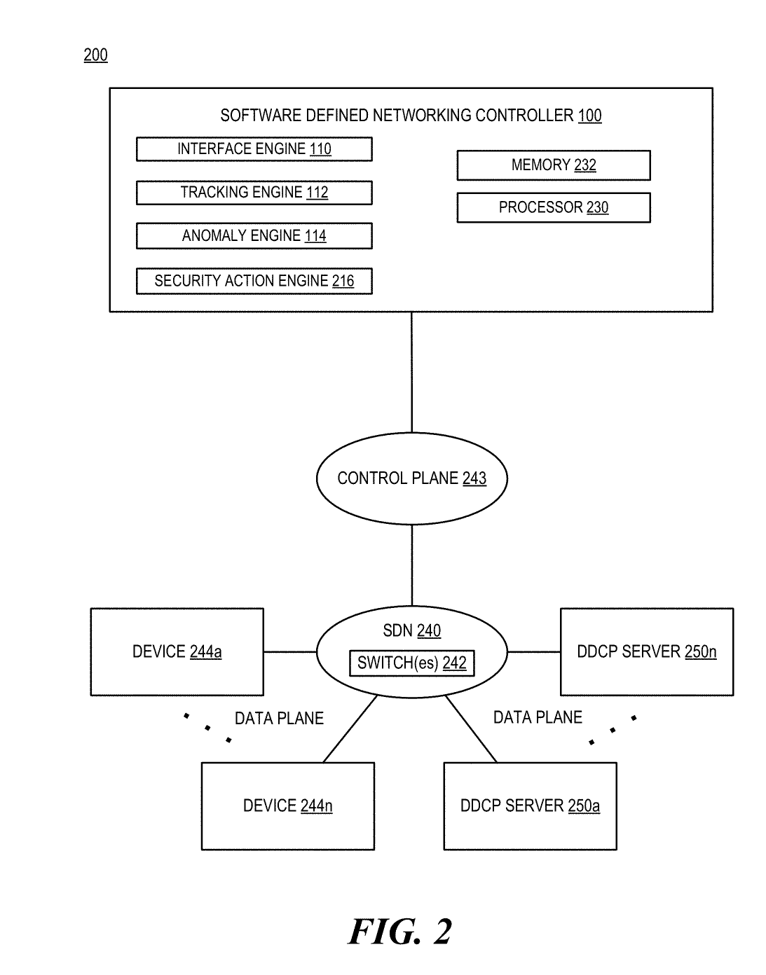

FIG. 1 is a block diagram of a Software Defined Networking controller capable of determining an anomaly from monitoring of Dynamic Device Configuration Protocol offers, according to one example. FIG. 2 is a block diagram of a system including the Software Defined Networking controller capable of determining an anomaly from monitoring of Dynamic Device Configuration offers, according to one example.

In one example, SDN controller 100 can include an interface engine 110, a tracking engine 112, and an anomaly engine 114. In another example, the SDN controller 100 can also include a security action engine 216, at least one processor 230, and memory 232. The SDN controller 100 can be implemented as part of a system 200, which can include a Software Defined Network 240 that is connected to the SDN controller 100 via a control plane 243. One or more SDN controllers can be used to control the SDN 240. The SDN 240 can be implemented using a network fabric that may include wired and wireless network elements, such as switches 242, routers, bridges, wireless access points, and the like. In certain examples, a switch 242 or network switch is a computer networking device that connects devices together in a computer network by using packet switching to forward data to a destination device. A switch can also act as or be included in a bridge, a router, other network elements, etc. A SDN 240 separates the control plane 243 from the data plane, such that a network controller (here, SDN controller 100) can make decisions regarding where and how network traffic is to be sent while the data plane (here, user communications on the SDN 240) can be programmed by the network controller to forward and manipulate the traffic. In certain examples, there is also an application plane consisting of one or more SDN applications whose functionality can be implemented by the network controller.

The SDN 240 can implemented such that devices 244a-244n can access other devices in the SDN 240 and/or other devices (e.g., via a gateway or multiple gateways to the Internet or other network). DDCP servers 250a-250n can be tracked based on communications.

As used herein, DDCP is a protocol used on networks for dynamically distributing network configuration parameters (e.g., addresses such as IP addresses, network parameters, etc.). The DDCP protocol includes at least one message from a client device 244 to the network to ask for an address from a DDCP server 250 on the network. Further, the DDCP protocol includes at least one message from the DDCP server 250 offering an address to the client device 244.

In one example, DDCP can use a 4-way handshake for new clients. The first portion of the handshake includes the client device 244 broadcasting to the network a “DDCP Discover,” which is an advertisement asking any DDCP servers 250 for an address. The second portion is unicast from the respective DDCP server 250 to the client device 244. This portion is a “DDCP Offer” where the DDCP server responds to the client with an address that the DDCP server can provide to the client device 244. The third portion includes a broadcast from the client device 244 to the network that has a “DDCP Request,” where the client device 244 has reviewed the offer(s) and requests a specific address. The fourth portion is a unicast from the DDCP server 250 to the client device 244 with a “DDCP Acknowledgement/Negative Acknowledgement (ACK/NAK)” where the DDCP server 250 acknowledges use of the address by the client device 244 or rejects it. Further, in some examples, a DDCP information message can be requested by the client device 244. Moreover, in some examples, the client device 244 can send a “DDCP Release” message to the DDCP server 250 to release the IP address assigned to the client device 244. The DDCP server 250 can then open up that IP address for use.

The SDN controller 100 can manage network elements of the SDN 240 to send (e.g., forward) packets related to DDCP to the SDN controller 100 (e.g., via one or more switch(es) 242). The forwarding can be based on a header associated with a packet. In the example of DHCP for IPv4, packets can be tracked where based on a match of UDP source and destination port values. In this example, traffic that includes ip_proto=UDP, source port=67, and destination port=68 and/or traffic that includes ip_proto=UDP, source port=68, and destination port 67 can be monitored. As such, a switch can look at a header or multiple headers of a packet and send the packet to the SDN controller 100 via the control plane 243. In some examples, sending of the packet can include sending a copy of the packet, where another packet continues to its intended recipient. In other examples, sending the packet may include stopping regular distribution of the packet. In one example, the packets sent include the DDCP Offer packets. For other protocols, other Ethertypes, UDP source and destination port values, etc. can be monitored.

The interface engine 110 receives the DDCP Offer packets. The interface engine 110 can be implemented as an application programming interface. Further, the interface engine 110 may include a network interface card to communicate via the control plane 243. The interface engine 110 can be used to monitor DDCP Offers in the data plane of the network (e.g., SDN 240). In certain examples, a data plane is the portion of the network that carries user traffic. This is separate from the control plane 243, which can be used to control the network elements of the SDN 240. As noted, the offers can be sent to the interface engine 110 via one or more switches 242. The DDCP Offer includes information identifying the source DDCP server 250 (e.g., an IP address, a MAC address, etc.). In certain examples, the DDCP Offer can further include a destination (e.g., the device 244), an IP address of a server, an IP address of a gateway, IP address offered, combinations thereof, etc. Further, auxiliary data may be sent along with the DDCP Offer (e.g., as with OpenFlow). This may include the source port where the original packet was received by a sending switch 242. Other examples of contents of DDCP Offers include contents of DHCP offer packets. In some examples, DDCP packets/messages can include the same or similar information to corresponding DHCP packets/messages.

The tracking engine 112 can track an address range for each source of the DDCP Offers (e.g., respective DDCP servers 250). When the tracking engine 112 receives a DDCP Offer, the tracking engine 112 can determine whether the source (e.g., DDCP server 250a) has previously been seen. If the source has not previously been seen, the tracking engine 112 can determine which addresses the DDCP server 250a serves. This can be accomplished via probing. In some examples, when a new DDCP server is observed, a notification that a new DDCP server has been observed can be generated and sent to an administrator. In one example, the notification can be generated for a log. On another example, the notification can be sent via a message.

In one example, probing includes injection of packets by the SDN controller 100, via the control plane 243, to the DDCP server 250. Because the SDN has access to the DDCP packets, it can form messages to the DDCP server 250a and send the messages, via the control plane 243, to the SDN 240 to forward via the data plane to the DDCP server 250a. As such, in one example, the tracking engine 112 can cause injection of the packets to form the message(s) to the data plane to request a specific address from the DDCP server 250a. In the case of the DHCP, the message can be a DHCP request to the server for the specific address. In some examples, the SDN controller 100 can generate a fake machine identifier to perform the request. Because the SDN controller 100 has a strategic point of control for the SDN 240, it can form and inject packets, via one of the controlled switches 242, to go to the DDCP server 250a. In various examples, the SDN controller 100 can pretend to be various end-hosts at different locations with different MAC addresses. The DDCP server 250a responds with an ACK or a NAK. The SDN controller 100 can cause the SDN 240 (e.g., switches 242 in the SDN 240) to forward the ACK or NAK to the SDN controller 100. If the SDN controller receives an ACK, the tracking engine 112 can record that the DDCP server 250a is serves that IP address. A release notification can then be injected, by the interface engine 110, into the SDN 240, via the control plane 243 to the DDCP server 250a. In the example of DHCP, a DHCP Release message can be formed and sent to the server.

Multiple probes can be sent to the DDCP server 250a to determine the address range associated with the DDCP server 250a. One approach that can be used is to iteratively probe the DDCP server 250a to determine the address range. The probes can begin at the IP address seen as offered and go up and down. For example, if the IP address seen was 192.168.1.106, the probes may go to 192.168.1.107, 192.168.1.108, 109 . . . , and so on in one direction and 192.168.1.105, 192.168.1.104, 103 . . . and so on in the other direction. In one example, this can be performed in each direction until a NAK is received. In another example, this can be performed in each direction until a threshold number of successive NAKs are received. In one example, the threshold number is more than 1. The using a threshold number of NAKs can be used to take into account that one or more of the addresses may have already been allocated. In some examples, the reception of a NAK indicates that the DDCP server 250a failed to provide an IP address. The address range associated to the DDCP server 250a would include the IP addresses of the successful IP address requests before failure.

As noted earlier, the addresses probed can also be released. In one example, the releasing can occur after each probe is sent. In another example, the releasing can occur after the probing is complete to determine the address range. The release requests can be specific to the IP address requested during the respective probes.

In other examples, other probing approaches can be used to determine the IP address range for the DDCP server 250a. Various boundary search approaches can be used. For example, a binary search approach can be used to determine the address range in each section. Probes can be sent for the boundaries of the address range. In one simple example, the subnet mask for the network can be 255.255.255.0. In this example, the IP address range requested by probes is based on the seen IP address as a start point (e.g., if the IP address seen is 192.168.1.202, the upper bound can be found by doing a binary search between 192.168.1.202 and 192.168.1.255 and a lower bound can be found by doing a binary search between 192.168.1.1 and 192.168.1.202). Here, when looking for the upper bound, the highest addressable address (e.g., in this case, 192.168.1.255) can be tried, if it is an ACK, it can be the upper bound because it is already at the top of the addressable range. If it is a NAK, the midpoint between the start point and the tried boundary (in this case 192.168.1.229) can be used. If the midpoint could be one of 2 numbers, a floor or ceiling can consistently be used. If the midpoint is a NAK, the next midpoint to check is between the start point and the midpoint. If the midpoint is an ACK, the next midpoint to check is between the midpoint and the last tried address (192.168.1.255). This can be repeated until the upper boundary is found, which is when the binary search approach converges. Similarly, the lower boundary can be found. In other examples, the seen IP address need not be used, but probes can be sent to addresses using a start point in the middle or at random.

The highest addressable address can be gleamed from a subnet mask. In some examples, this is known to the SDN controller 100. In other examples, the subnet mask can be determined from an offer by the DDCP server. Moreover, if the offer does not include the subnet mask, the SDN controller 100 may request additional information including the subnet mask (e.g., in DHCP, via a DHCP information request). Moreover, if the subnet mask is not known, the highest addressable address may be determined from other information about the subnet. For example, the SDN controller 100 could assume that the subnet in the example above was 192.168.0.0/16 with the highest address in the range being 192.168.255.225. Similarly, in some examples, the lower bound of the addressable range of the subnet can be based on the subnet mask. In the example above with the subnet mask of 255.255.255.0, the lower bound to start the binary search can be 192.168.1.1 or 192.168.1.2 if there is a known network gateway installed at 192.168.1.1. The lower bound can change based on the subnet mask (e.g., if the subnet mask has a prefix size of /28, the addressable range may not start at 1).

In some examples, when a DDCP server 250 is first seen, an address range associated with it is found. Further, in some examples, an initiation phase can be put in place to determine a baseline of the DDCP servers 250 associated with the SDN 240. As such, these DDCP servers 250 can be considered as being known official DDCP servers 250.

When a new DDCP server 250 is found, the anomaly engine 114 can check to determine whether an anomaly exists. In some examples, an anomaly is a determination that an IP address in a DDCP Offer that is seen from a new DDCP server is within the address range of another DDCP server. As such, the anomaly engine 114 can determine whether a DDCP Offer that is sourced from a DDCP server is within the address range of another DDCP server. This can be based on the address range(s) associated with the respective DDCP servers.

The anomaly engine 114 can also determine a type of anomaly. In one example, a second DDCP server can be determined to have the same address range as a first or baseline DDCP server. Because both have the same address range, the second DDCP server may be considered redundant. The security action engine 216 may send a message logging or notifying an administrator about the redundancy.

In another example, the anomaly engine 114 can determine that the address range of a second DDCP server overlaps with the address range of a first or baseline server, but is not the same and therefore conflict. In this scenario, the second DDCP server can be considered a “rogue DDCP” server. In one example, the security action engine 216 can generate a notification about the conflict (e.g., to mark the DDCP server as rogue). The notification can be a log entry, an email, another message, etc.

In some examples, the security action engine 216 can cause injection of packets into the data plane to consume IP addresses provided by a rogue DDCP server. This can be accomplished in a similar manner as the probing. In one example, DDCP Requests can be formed and injected into the SDN 240 to be sent to the rogue DDCP server to consume the IP addresses. In one example, each of the IP addresses in the address range of the rogue DDCP server can be requested from the rogue DDCP server. With this approach, the rogue DDCP server is not able to serve additional addresses, but is still able to use the network. In other examples, the rogue DDCP server can be segregated (e.g., blocked). For example, the port that connects the DDCP server to the SDN 240 can block access to the DDCP server.

In the example of the rogue DDCP server being a rogue DHCP server, a DHCP request can be injected. Further, confirmation that each address was taken can be determined by the security action engine 216 because of DHCP acknowledgement messages sent by the rogue DHCP server to confirm the handshake. The SDN controller 100 can be forwarded packets for these messages based on a configuration of the SDN 240.

Further, in one example, the anomaly engine 114 can determine that an anomaly does not exist when a second DDCP server makes an offer with an address range of a baseline DDCP server if the baseline DDCP server is offline (e.g., disconnected).

Moreover, in one example, if a DDCP server is seen to offer an address outside of its address range, it can be flagged. In one example, the tracking engine 112 can re-probe the DDCP server for its address range. In another example, the security action engine 216 marks the DDCP server as a rogue.

In one example, the SDN controller 100 can implement one or more phantom hosts. The phantom hosts could act as a honeypot for rogue DDCP servers. This can be implemented by the SDN controller 100 periodically injecting packets into the SDN 240 via the switch(es) 242 to ask for an offer for an address (in the example of DHCP, a DHCP Discover). The DDCP servers can then respond with offers. These offers can be monitored by the SDN controller 100 instead of going to a real host. This lets the SDN controller 100 monitor DDCP servers, with a known window of when the DDCP servers begin to serve addresses on the network. This type of timing information can be used to determine which DDCP servers should be considered official (e.g., because they have been active for a threshold time). In some examples, the phantom host can request a specific address from each DDCP server 250 and release it.

In some examples, further analysis can be performed on this time data. For example, if a DDCP server goes offline and online repeatedly, this can be an issue. This can represent the DDCP server being mobile, which is suspicious. As such, more analysis can be performed and a security action taken by the security action engine 216.

In addition to the security actions mentioned above, the SDN controller 100 can use a phantom host to determine more information from a DDCP server 250. For example, this would let the SDN controller 100 interact with the DDCP server 250 while acting in the guise of the phantom host. With this approach, the SDN controller can request additional information from the DDCP server 250 that may be able to help distinguish the DDCP server as benign or malicious.

In one example of using a phantom host to distinguish whether a DDCP server is benign or malicious, the DDCP server could offer an address that was within the address range associated with a baseline DDCP server. The SDN controller 100 can ping the baseline DDCP server (e.g., via the phantom host) to determine whether the baseline DDCP server was still reachable.

In another example, the SDN controller 100 can probe L4 ports on a DDCP server (e.g., one that is new to the system, one that shows an anomaly, etc.). The probing can be used to determine which operating system (OS) is running on the DDCP server, what applications are running on the DDCP server, and the like.

As noted, system 200 includes devices 244 that communicate with other devices via the SDN 240. In certain examples, the devices 244, 250 are computing devices, such as servers, client computers, desktop computers, mobile computers, etc. In other embodiments, the devices 244 can include special purpose machines. The devices 244, 250 can be implemented via a processing element, memory, and/or other components.

The devices can be connected to other devices via a communication network (e.g., via SDN 240). The communication network can use wired communications, wireless communications, or combinations thereof. Further, the communication network can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc.

By way of example, the devices communicate with each other and other components with access to the communication network via a communication protocol or multiple protocols. A protocol can be a set of rules that defines how nodes of the communication network interact with other nodes. Further, communications between network nodes can be implemented by exchanging discrete packets of data or sending messages. Packets can include header information associated with a protocol (e.g., information on the location of the network node(s) to contact) as well as payload information.

The engines 110, 112, 114, 216 include hardware and/or combinations of hardware and programming to perform functions provided herein. Moreover, the modules (not shown) can include programing functions and/or combinations of programming functions to be executed by hardware as provided herein. When discussing the engines and modules, it is noted that functionality attributed to an engine can also be attributed to the corresponding module and vice versa. Moreover, functionality attributed to a particular module and/or engine may also be implemented using another module and/or engine.

Modules (not shown) may include, for example, hardware devices including electronic circuitry for implementing the functionality described herein. In addition or as an alternative, each module may be implemented as a series of instructions encoded on a machine-readable storage medium and executable by at least one processor. It should be noted that, in some embodiments, some modules are implemented as hardware devices, while other modules are implemented as executable instructions.

A processor 230, such as a central processing unit (CPU) or a microprocessor suitable for retrieval and execution of instructions and/or electronic circuits can be configured to perform the functionality of any of the engines or modules described herein. In certain scenarios, instructions and/or other information, such as data structures including address ranges, can be included in memory 232 or other memory. Moreover, in certain embodiments, some components can be utilized to implement functionality of other components described herein.

In some examples, injection of packets can be accomplished via a service insertion. Service insertion is transparently inserting an external service (e.g., tracking by the SDN controller 100) into a traffic flow or into the traffic processing pipeline. Flows can be redirected to the service provided by the SDN controller 100 and reinjected to a forwarding pipeline. In one example, a DDCP packet can be forwarded from the SDN 240 to the SDN controller 100 and reinjected once processed (unless a decision is made not to). In other examples, a copy can be sent to the SDN controller 100. Hardware IP tunnels can be used to enable service insertion.

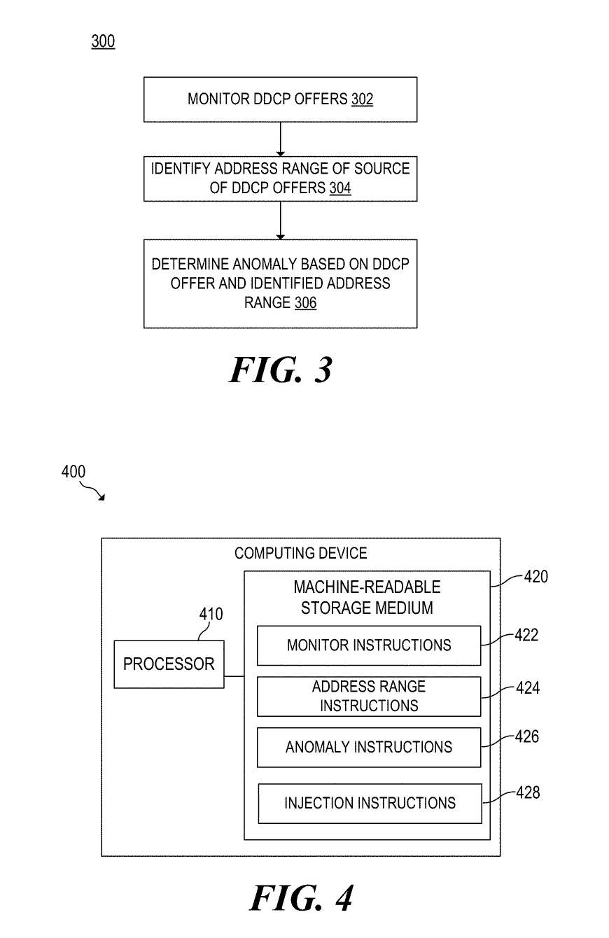

FIG. 3 is a flowchart of a method for determining an anomaly based on identified address ranges of Dynamic Device Configuration Protocol servers, according to one example. FIG. 4 is a block diagram of a computing device capable of determining an anomaly based on identified address ranges of Dynamic Device Configuration Protocol servers, according to one example.

Although execution of method 300 is described below with reference to computing device 400, other suitable components for execution of method 300 can be utilized (e.g., SDN controller 100). Additionally, the components for executing the method 300 may be spread among multiple devices. Method 300 may be implemented in the form of executable instructions stored on a machine-readable storage medium, such as storage medium 420, and/or in the form of electronic circuitry.

Processor 410 may include at least one central processing unit (CPU), at least one semiconductor-based microprocessor, at least one graphics processing unit (GPU), at least one network processor, other hardware devices suitable for retrieval and execution of instructions stored in machine-readable storage medium 420, or combinations thereof. For example, the processor 410 may include multiple cores on a chip, include multiple cores across multiple chips, multiple cores across multiple devices (e.g., if the computing device 400 includes multiple node devices), or combinations thereof. Processor 410 may fetch, decode, and execute instructions 422, 424, 426, 428 to implement method 300. As an alternative or in addition to retrieving and executing instructions, processor 410 may include at least one integrated circuit (IC), other control logic, other electronic circuits, or combinations thereof that include a number of electronic components for performing the functionality of instructions 422, 424, 426, 428.

Machine-readable storage medium 420 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 420 may be encoded with a series of executable instructions for associating nodes with labels. Further, in some examples, the various instructions 422, 424, 426, 428 can be stored on different media.

At 302, at least one processor 410 of the computing device 400 executes the monitor instructions 422 to monitor DDCP Offers in a data plane of a network. The DDCP Offers can be forwarded from a network switch or respective network switches of the network. The computing device 400 can communicate with the network switch(es) via a control plane, while the DDCP Offers are communicated on the data plane. As noted above, the respective DDCP Offers can originate from respective source servers.

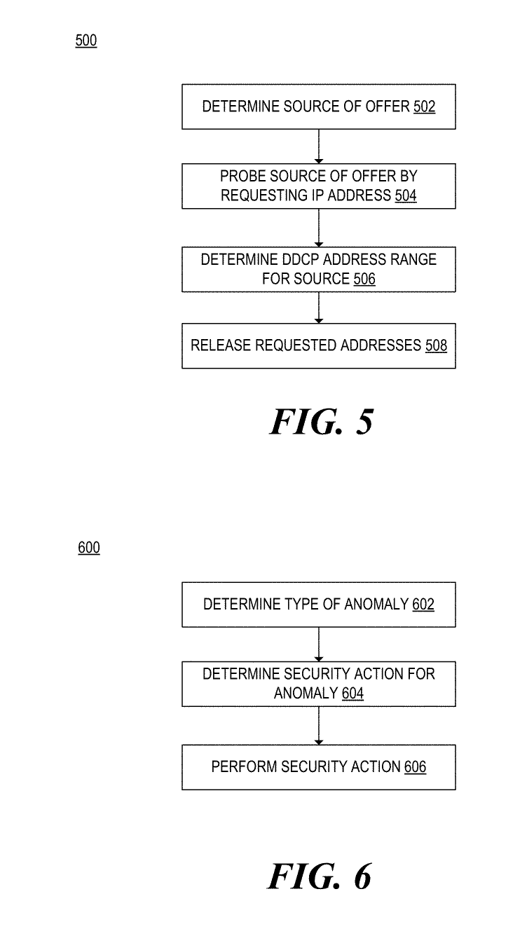

At 304, address range instructions 424 can be executed by the processor(s) 410 to identify an address range for each source server. This can be based, at least in part, on the DDCP Offer(s) and probing of the associated server. Injection instructions 428 can be executed to inject packets into the data plane to communicate with the respective servers as noted above. Probing is further in the description associated with FIG. 5. As such, an address range can be determined for each source server detected to provide an offer on the network. The information can be stored as a data structure (e.g., a table or list) in memory of the computing device 400.

At 306, anomaly instructions 426 can be executed to determine an anomaly based on one of the DDCP Offers and the identified address range of one of the servers. In this scenario, the address range can be one of an identified server. This may be, for example, an official or known server with the address range. The DDCP Offer can be associated with another server (e.g., a new server). In this example, the DDCP Offer includes an IP address that is already in the address range of the identified server. In one example, the new server can be labeled as rogue and remedial actions can be taken (e.g., requesting all of the addresses served by the rogue server, disconnecting the rogue server, as further described in FIG. 6, etc.).

In another example, the address range of the new server can be probed. In this example, if the address range of the new server matches the address range of the known server, the new server can be marked as a redundant server. Moreover, in some examples, the anomaly can be checked based on whether the known server is still online. If the known server is not online, this new server may not be a rogue server, but instead a new replacement for the known server.

The computing device 400 can periodically ping (e.g., by executing injection instructions 428 to inject packets into the data plane) the network to request offers. In one example, the computing device 400 can do this by implementing a phantom host or multiple phantom hosts that can act as a honeypot for receiving DDCP Offers. The periodic pinging can provide timing information as to when certain DDCP servers are online or offline, when a new DDCP server comes online, etc.

FIG. 5 is a flowchart of a method for probing Dynamic Device Configuration Protocol servers for served address ranges, according to one example. Although execution of method 500 is described below with reference to computing device 400, other suitable components for execution of method 500 can be utilized (e.g., SDN controller 100). Additionally, the components for executing the method 600 may be spread among multiple devices. Method 500 may be implemented in the form of executable instructions stored on a machine-readable storage medium, such as storage medium 420, and/or in the form of electronic circuitry.

As noted above, DDCP traffic is monitored by a SDN controller (e.g., implemented in the form of computing device 400). The SDN network fabric can be configured to forward DDCP traffic as noted above. Monitor instructions 422 can be executed to monitor the traffic via one or more interfaces of the computing device 400. The traffic includes DDCP Offer messages. When an offer is received at the computing device 400 can determine a source (e.g., a DDCP server) of the offer at 502. This can include an IP address, a MAC identifier, one or more ports associated, combinations thereof, etc. and can be parsed from the offer message and/or a header associated with the message. For example, in an implementation of OpenFlow, a source port can be identified in an OpenFlow header that encapsulates a copied offer. The offer can also identify the IP address offered by the DDCP server. This information can identify the DDCP server. In one example, if the offered address is within an associated address range for the DDCP server, then no further action is taken. In other examples (e.g., when the DDCP server has not previously been identified as offering addresses or if the IP address offered is outside of the current identified DDCP server address range), the address range of the DDCP server is probed.

At 504, address range instructions 424 can be executed to probe the source DDCP server to determine an associated address range. As noted above, the probing can be implemented by executing injection instructions 428 to cause injection of DDCP Request packets to the DDCP server. The computing device 400 can send packets, via the control plane, to switches to output the packets to the data plane for the source DDCP server. As noted above, various approaches can be used to determine the address range associated with the DDCP server (e.g., via an iterative approach, a binary approach to find the boundaries, and the like). The packets can request a specific address from the DDCP server for each probed address. Further, the probes can be formed to imitate various end-hosts. In some examples, the switches in the network can be configured to send messages to these imitated end-hosts to the computing device via the control plane. The DDCP server can respond to the requests with responses. The responses can include an ACK that the requested address is to be assigned to that end-host or a NAK. These can be sent to the respective imitated end-hosts and can be forwarded on the control plane to the computing device 400. As noted above, the address range associated with the source DDCP server can be determined based on the responses (506).

Further, at 508, injection instructions 428 can be executed to inject packets to release the addresses probed. As noted above, these packets can request the release of the respective IP addresses. In one example, the IP address is identified for the release. In another example, the imitated end-host is identified and the DDCP server can use that information to release. The DDCP server releases the IP address so it can be used later. As noted above, the release requests can occur during probing or after the address range has been identified.

FIG. 6 is a flowchart of a method for performing a security action based on a determined anomaly, according to one example. Although execution of method 600 is described below with reference to computing device 400, other suitable components for execution of method 600 can be utilized (e.g., SDN controller 100). Additionally, the components for executing the method 600 may be spread among multiple devices. Method 600 may be implemented in the form of executable instructions stored on a machine-readable storage medium, such as storage medium 420, and/or in the form of electronic circuitry. As noted above, anomalies can be determined based on the identification of an IP address offered by a DDCP server (e.g., a DDCP server that is currently being monitored) that is within the address range of another DDCP server (e.g., a baseline DDCP server) in the network.

At 602, anomaly instructions 426 can be executed by processor 410 to determine a type of anomaly. This can be based on various factors. The factors can include the address range of both the monitored DDCP server as well as the baseline DDCP server, probing, whether the baseline DDCP server is online, etc. At 604, a security action can be determined for the anomaly. Then, at 606, the security action can be performed.

In one example, the computing device 400 can determine that both the monitored DDCP server and the baseline DDCP server have the same address range. This can lead to the inference that the monitored DDCP server is a backup. The security action to inform (e.g., log or send a message) a network administrator of the backup can be determined and performed. In other examples, the security action may include some sort of hindering. For example, if time between when the baseline DDCP server is first seen and the monitored DDCP server is below a threshold amount, both can be marked as suspicious and hindered. Hindering can include injecting packets into the data plane to consume IP addresses provided by the rogue DDCP server. Hindering can also include restricting or stopping access to the DDCP server (e.g., by blocking communications via at least one switch).

In another example, the computing device 400 can determine that the monitored DDCP server and the baseline DDCP server overlap, but have different address ranges and therefore conflict. This can lead to the inference that the monitored DDCP server is rogue. In one example, the security action can include informing (e.g., log or send a message) a network administrator of the conflict. A notification can be generated and sent. In another example, the security action can include hindering the rogue DDCP server.

What is claimed is:

1. A software defined networking (SDN) controller, comprising:
an interface engine to monitor a plurality of Dynamic Device Configuration Protocol (DDCP) Offers in a data plane of a network via at least one network switch of the network, wherein the SDN controller communicates with the at least one network switch via a control plane;
a tracking engine to track at least one respective address range of respective sources of the DDCP Offers; and
an anomaly engine to determine that another DDCP Offer is within the at least one respective address range and that the other DDCP Offer is sourced from another source that is not the respective source associated with the at least one respective address range.

2. The SDN controller of claim 1, further comprising:
a security action engine to inject at least one packet into the data plane to the other source to consume Internet Protocol addresses provided by the other source based on an address associated with the other DDCP Offer.

3. The SDN controller of claim 1, wherein the tracking engine causes injection of a first plurality of first packets into the data plane each to request a specific address from a first source of the sources to determine a corresponding first one of the at least one respective address range.

4. The SDN controller of claim 3, wherein the tracking engine further causes injection of a second plurality of second packets corresponding to the first packets, each to release the respective specific address.

5. The SDN controller of claim 3, wherein the respective specific addresses begin at an address associated with one of the DDCP Offers corresponding to the first source and iterate in each direction by one until a threshold number of successive failures is occur.

6. The SDN controller of claim 3, wherein the respective specific addresses are based on a binary search approach.

7. The SDN controller of claim 1, further comprising:
a security action engine,
wherein the sources include a first source and a second source respectively associated with a first address range and a second address range of the at least one address range, and
wherein the anomaly engine is further to determine that the first address range and the second address range overlap, but are not the same, and therefore conflict, and
wherein the security action engine generates a notification about the conflict.

8. The SDN controller of claim 1, wherein the DDCP is a Dynamic Host Configuration Protocol, and wherein the interface engine is further to inject a packet into the data plane to determine whether the respective source associated with the at least one respective address range is available, and wherein the anomaly engine determination is further based on the availability.

9. A method comprising:
monitoring, by at least one processor, a plurality of Dynamic Device Configuration Protocol (DDCP) Offers in a data plane of a network via at least one network switch of the network, wherein the at least one processor communicates with the at least one network switch via a control plane,
wherein each of the DDCP Offers originate from a respective source server,
identifying an address range for each source server based, at least in part, on the respective DDCP Offers and probing of each source server; and
determining an anomaly based on one of the DDCP Offers and the identified address range for another source server.

10. The method of claim 9, wherein probing of each source server includes, for the respective source server,
causing, by the at least one processor, injection of a plurality of packets into the data plane for the respective source server,
wherein the packets each request a specific address from the respective source server,
wherein a plurality of responses, to the respective requests, on the data plane from the source server are forwarded to the at least one processor on the control plane via the at least one network switch, and
wherein the address range associated with the respective source server is based on the responses.

11. The method of claim 9, wherein the respective source servers include a first source server and a second source server respectively associated with a first address range and a second address range, the method further comprising:
determining that the first address range and the second address range overlap, but are not the same, and therefore conflict; and
generating a notification about the conflict.

12. The method of claim 9, further comprising:
periodically injecting packets, by the at least one processor, into the data plane to request at least some of the DDCP Offers.

13. A non-transitory machine-readable storage medium storing instructions that, if executed by at least one processor of a device, cause the device to:
monitor a plurality of Dynamic Device Configuration Protocol (DDCP) Offers in a data plane of a network via at least one network switch of the network, wherein the device communicates with the at least one network switch via a control plane,
wherein each of the DDCP Offers originate from a respective source server,
identify an address range for each source server based, at least in part, on the respective DDCP Offers and probing of each source server;
determine an anomaly based on one of the DDCP Offers and the identified address range for another source server;
determine, based on the anomaly, that the respective source server for the one DDCP Offer is a rogue DDCP server; and
based on the determination of the rogue DDCP server, inject a plurality of packets into the data plane to the rogue DDCP server to consume Internet Protocol addresses provided by the rogue DDCP server.

14. The non-transitory machine-readable storage medium of claim 13, further comprising instructions that, if executed by the at least one processor, cause the device to:
cause injection of a second plurality of packets into the data plane for the respective source server,
wherein the second packets each request a specific address from the respective source server,
wherein a plurality of responses, to the respective requests, on the data plane from the source server are received at the device on the control plane via the at least one network switch, and
wherein the address range associated with the respective source server is based on the responses.

15. The non-transitory machine-readable storage medium of claim 13, further comprising instructions that, if executed by the at least one processor, cause the SDN controller to:
cause injection of a third plurality of packets into the data plan for the respective source server, wherein the third packets each release the respective specific address from the respective source server.
